(19) United States
(12) Patent Application Publication
(10) Pub. No.: US 2010/0169085 A1
(43) Pub. Date: Jul. 1, 2010

(54) MODEL BASED REAL TIME PITCH TRACKING SYSTEM AND SINGER EVALUATION METHOD

(75) Inventors: KALURI V RANGA RAO, Hyderabad (IN); SATISH KATHIRISETTI, Hyderabad (IN); SRIDHAR VENKATANARASIMHAN, Hyderabad (IN)

Correspondence Address: CHOBIN & CHOBIN CONSULTANCY L.L.C, Green Community, Building 3, Ground Floor, Dubai Investment Park, P.O Box 212880, Dubai, AE

(73) Assignee: TANLA SOLUTIONS LIMITED, Hyderabad (IN)

(21) Appl. No.: 12/647,449

(22) Filed: Dec. 26, 2009

(30) Foreign Application Priority Data
Dec. 27, 2008 (IN) 2970/CHE/2008

(51) Int. Cl. G10L 19/12

(52) U.S. Cl. 704/207; 704/E19.036

(57) ABSTRACT

The various embodiments herein provide a system and method to track the pitch of a human being in real time using time varying model. According to one embodiment, the input voice is synthesised to obtain a lower order model. The lower model is down sampled and fitted to a time varying 2nd order model. The down sampled signal is passed through a pitch tracking filter, a fading filter and a gradient filter to obtain a pitch signal in real time. The noise included in the pitch signal is removed by passing the acquired pitch signal through a Kalman filter to obtain a smoothened pitch signal in real time.

### BACKGROUND

1. Technical Field

The embodiments herein generally relates to the voice synthesizers or speech synthesizers and particularly to a pitch tracking system for human voice. The embodiments herein more particularly relates to a real time dynamic pitch tracking system for use in mobile communication system and a singer evaluation method using the real time dynamic pitch tracking system.

2. Description of the Related Art

Over the past few years, the practice of voice tracking in many applications has grown. The property of voice which we call pitch is determined by the rate of vibration of the vocal cords. Pitch tracking is important in some speech processing applications. With such a wide range of interest, the researchers have worked on constructing the pitch determination algorithms that are ideal for their application. Despite advances in mobile communication, the pitch tracking in real-time remains quite a challenge. Accurate speech recognition systems typically depend on algorithms and complex statistical models.

Pitch is the fundamental frequency of the repetitive portion of the voice wave form. Pitch is typically measured in terms of the time period of the repetitive segments of the voiced portion of the speech wave forms. The speech waveform is a highly complex waveform and very rich in harmonics. The complexity of the speech waveform makes it very difficult to extract pitch information.

The basic categories of the pitch tracking methods include a frequency domain analysis and a time domain analysis. Frequency domain analysis utilizes Fourier analysis to transform a window of a signal from amplitude vs. time to amplitude vs. frequency and compute a frequency using the Fourier components. Time domain analysis is performed on the window of the signal without transforming it to the frequency domain and performing calculations on the original signal to determine the pitch.

Various pitch detection algorithms have been developed in the past years. Pitch tracking is not really new, but the currently available system uses complex computational algorithms.

None of the currently available pitch tracking systems estimate and track the pitch of a human being dynamically in real time and in easy manner. Hence there is a need for a dynamic real time pitch tracking system for mobile communication system.

The abovementioned shortcomings, disadvantages and problems are addressed herein and which will be understood by reading and studying the following specification.

### SUMMARY

The primary object of the embodiments herein is to develop a system to estimate the pitch of the voice of a human being in real time easily using an algorithm.

Another object of the embodiments herein is to develop a system to track the pitch of the voice of a human being dynamically using a time varying model.

Yet another object of the embodiments herein is to develop a system for singer evaluation in real time.

Yet another object of the embodiments herein is to develop a system for short term identification of songs and human vocabulary.

These and other objects and advantages of the embodiments herein will become readily apparent from the following detailed description taken in conjunction with the accompanying drawings.

The various embodiments herein provide a system and method to track the pitch of the voice of a human being in real time using time varying model. According to one embodiment, the input voice is synthesized into a sum of two time series namely into a higher order model (HOM) and a lower order model (LOM). In the current method of tracking the pitch in real time, the voice time series Vlk is extracted from the input voice Vk by passing the input voice into 6th order low pass Butterworth filter. The output of the filter is down sampled and fitted to a time varying 2nd order time varying model. The signal after fitting with a time varying model is passed through a pitch tracking filter to obtain the pitch frequency. The estimated pitch is smoothened using a 2nd order. Kalman filter to remove the noise in the pitch.

According to one embodiment, a model based real time pitch tracking system has a low pass filter. A down sampler is connected to the low pass filter. A second order band pass filter is connected to the down sampler. A Gradient filter is connected to the second order band pass filter. A fading filter is connected to the second order band pass filter. An integrator is connected to the fading filter and to the gradient filter. A first order filter is connected to an integrator. A pitch frequency estimator is connected to the first order filter. A smoothing filter is connected to the pitch frequency estimator.

A lower order model is separated from an input voice time series to perform a pitch tracking process in real time.

The low pass filter is a sixth order low pass Butterworth filter to receive the input voice series and to extract a lower order voice series from the input voice series in real time. The down sampler performs the down sampling of the extracted lower order voice series to obtain a low order voice signal. The second order band pass filter is connected to the down sampler and is provided with an algorithm to fit a second order time varying model to the output of the down sampler to obtain the model parameters related to the lower order voice series of the input voice.

The fading filter is connected to the output of the second order band pass filter through an adder. The fading filter is connected to the input of the second order band pass filter through a first delay unit. The fading filter is connected to the second order band pass filter to calculate an error value in the measurement of the lower order voice in a pitch tracking process.

The gradient filter is connected to the second order band pass filter and is provided with an algorithm to calculate a gradient of the measured error value in the measurement of the lower order voice in a pitch tracking process. The integrator is connected to the gradient filter through a second delay unit to receive the gradient of the measured error value. The integrator is connected to the input and to the output of the fading filter to receive the input lower order voice and the measured error value. The integrator is connected to the fading filter and the gradient filter to calculate a model parameter related to the pitch of the lower order voice. The pitch frequency estimator is connected to the integrator through a first order filter to receive the output of the integrator to calculate a pitch value of the input voice. The smoothing filter is connected to the pitch frequency estimator to obtain a smooth pitch. The smoothing filter is a second order Kalman filter.

According to another embodiment, a singer evaluation method using the model based real time pitch tracking system is provided. According to the method, an interactive voice response system is accessed through a communication means by a singer. A song is selected by the singer for singing. The selected song is played.

Then the selected song is sung by the singer. The song sung by the singer is recorded. The song sung by the singer is compared and evaluated with the selected reference song to calculate a score. The evaluation result is displayed. The process of evaluating includes estimating the pitch of the singer and the pitch of the reference singer who has played the reference singer to calculate the score corresponding to the degree of matching between the singer and the reference singer.

The process of accessing interactive voice response system involves initiating a phone call using a fixed line or a mobile phone. The process of selecting a song for singing involves selecting a desired song from a list of songs stored in a database. The process of selecting further comprises selecting options including language, gender and songs.

The method further comprises a process of selecting a listening option or recording option at the end of the playing of the selected song by a singer. The selected song is played again when the listening option is chosen by the singer. The recording option is selected by the singer to record the song sung by the singer. The process of recording the song sung by the singer includes playing karaoke during the singing of the selected song by the singer. The process of recording the song sung by the singer involves playing the recorded song along with karaoke and returning back to the recording mode after playing the recorded song sung by the singer. The process of recording involves enabling the singer to sing the selected song for any number of times until the singer is satisfied with the recorded song. The process of evaluating the song sung by the singer is initiated after receiving a confirmation of the recorded song from the singer.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 shows a block diagram illustrating the decomposition of the human voice into a higher order model and a lower order model.

FIG. 2 illustrates a frequency domain decomposition of a lower order model and a higher order model and a voice signal with respect to time.

FIG. 3 shows a curve illustrating the variation of pitch frequency of the female and male singers for the same song.

FIG. 4 shows a block diagram of a model based pitch tracking system according to one embodiment.

FIG. 5 shows a block diagram of a system an integrated multimodal real time pitch tracking system for evaluating the pseudo pitch/signature of a song sung by the singer according to one embodiment.

FIG. 6 shows a flow chart explaining the process of evaluating a singer using the model based pitch tracking system according to one embodiment.

Although specific features of the embodiments herein are shown in some drawings and not in others. This is done for convenience only as each feature may be combined with any or all of the other features in accordance with the embodiments herein.

### DETAILED DESCRIPTION

In the following detailed description, reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

The various embodiments herein provide a system and method to track the pitch of a human being in real time using time varying model. According to one embodiment, the input voice is synthesised to obtain a lower order model. The lower model is down sampled and fitted to a time varying 2nd order model. The down sampled signal is passed through a pitch tracking filter, a fading filter and a gradient filter to obtain a pitch signal in real time. The noise included in the pitch signal is removed by passing the acquired pitch signal through a Kalman filter to obtain a smoothened pitch signal in real time.

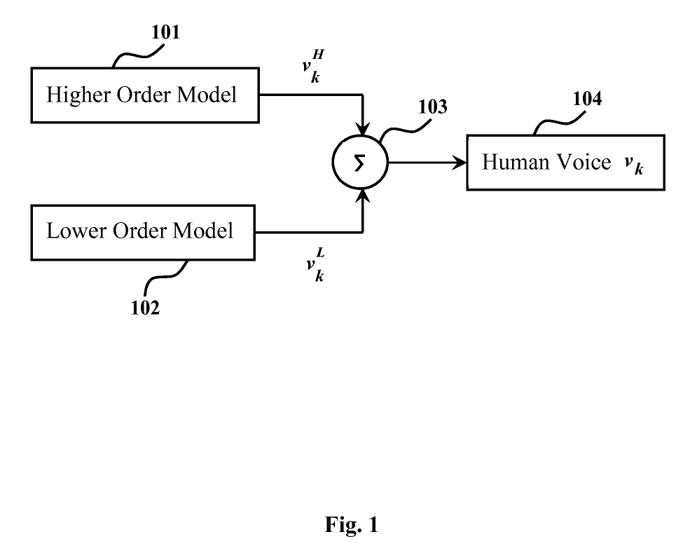

FIG. 1 shows a block diagram illustrating the decomposition of the human voice into a higher order model and a lower order model. With respect to FIG. 1, an input voice 104 is split into a lower order voice series 102 and a higher order voice series 101 using a low pass Butterworth filter 103.

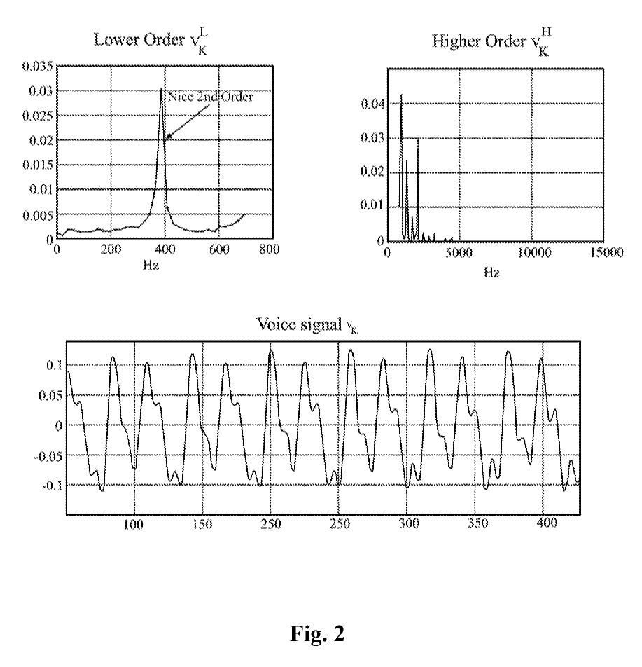

FIG. 2 illustrates a frequency domain decomposition of a lower order model and a higher order model and a voice signal with respect to time. An example voice time series is shown in FIG. 2. The Frequency domain decomposition into LOM and HOM respectively is depicted in FIG. 2. By examining LOM in FIG. 2, it is seen clearly that a 2nd order model is very close to the input voice series and hence the 2nd order model is used for tracking pitch.

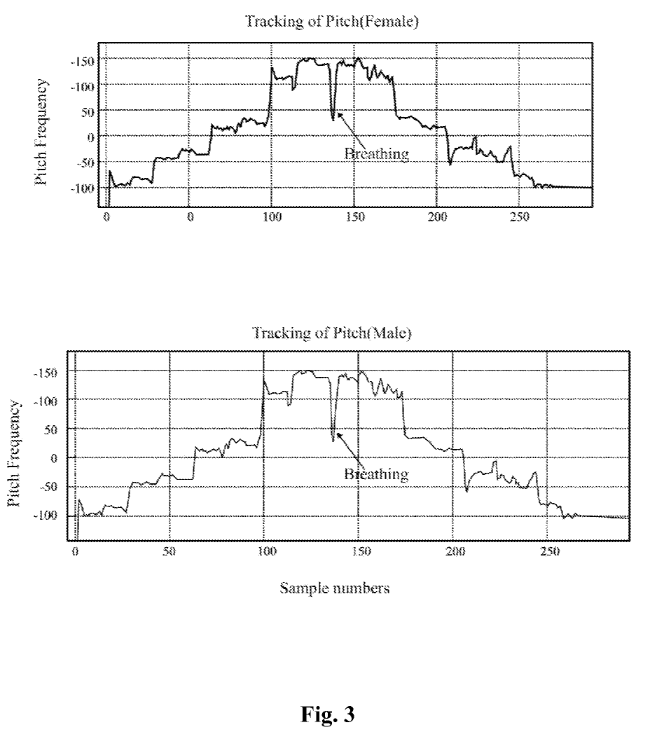

FIG. 3 shows a curve illustrating the variation of pitch frequency of the female and male singers for the same song. FIG. 3 shows the pitch values for the “same song” sung by a female singer and a male singer. The pitch values in the FIG. 3 have been obtained after subtracting from the mean pitch value. The female pitch varies about 300 Hz and for the male it is about 150 to 200 Hz from the mean. These test results show how the algorithm is indeed used in tracking the pitch.

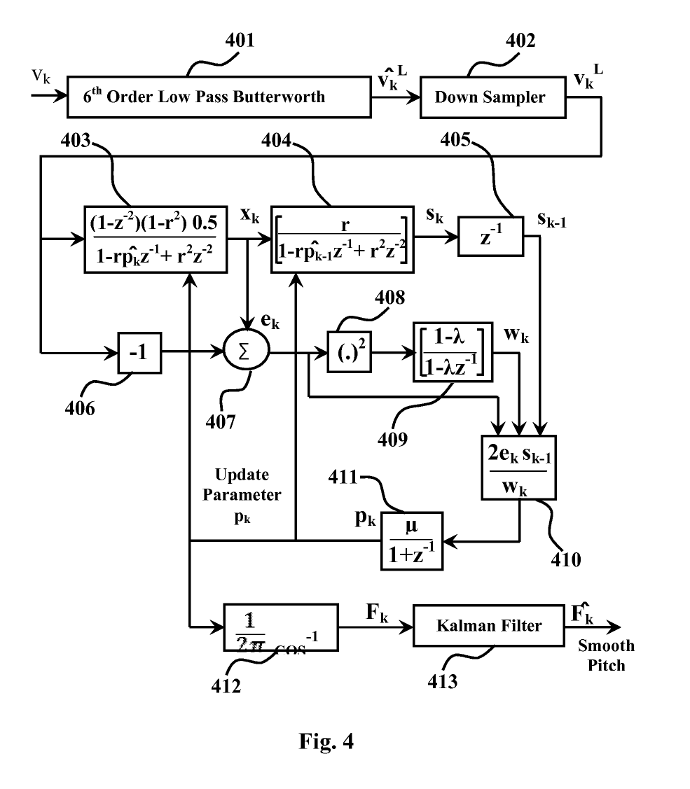

FIG. 4 shows a block diagram of a model based pitch tracking system according to one embodiment. With respect to FIG. 4, a model based real time pitch tracking system has a low pass filter 401. A down sampler is connected to the low pass filter 402. A second order band pass filter 403 is connected to the down sampler 402. A Gradient filter 404 is connected to the second order band pass filter 401. A fading filter 409 is connected to the second order band pass filter 401. An integrator 410 is connected to the fading filter 409 and to the gradient filter 404. A first order filter 411 is connected to the integrator 410. A pitch frequency estimator 412 is connected to the first order filter 411. A smoothing filter 413 is connected to the pitch frequency estimator 412.

A lower order model is separated from an input voice time series to perform a pitch tracking process in real time. The low pass filter is a sixth order low pass Butterworth filter 401 to receive the input voice series and to extract a lower order voice series from the input voice series in real time. The down sampler 402 performs the down sampling of the extracted lower order voice series to obtain a low order voice signal. The second order band pass filter 403 is connected to the down sampler 402 and is provided with an algorithm to fit a second order time varying model to the output of the down sampler 402 to obtain the model parameters related to the lower order voice series of the input voice.

The fading filter 409 is connected to the output of the second order band pass filter 403 through an adder 407. The fading filter 409 is connected to the input of the second order band pass filter 403 through a first delay unit 406. The fading filter 409 is connected to the second order band pass filter 403 to calculate an error value in the measurement of the lower order voice in a pitch tracking process.

The gradient filter 404 is connected to the second order band pass filter 403 and is provided with an algorithm to calculate a gradient of the measured error value in the measurement of the lower order voice in a pitch tracking process. The integrator 410 is connected to the gradient filter 404 through a second delay unit 405 to receive the gradient of the measured error value. The integrator 410 is connected to the input and to the output of the fading filter 409 to receive the input lower order voice and the measured error value. The integrator 410 is connected to the fading filter 409 and the gradient filter 404 to calculate a model parameter related to the pitch of the lower order voice. The pitch frequency estimator 412 is connected to the integrator 410 through a first order filter 411 to receive the output of the integrator to calculate a pitch value of the input voice. The smoothing filter 413 is connected to the pitch frequency estimator 412 to obtain a smooth pitch. The smoothing filter is a second order Kalman filter 413.

According to the method, the pitch tracking in real-time is performed by extracting the time series (LOM) vₖ^{L} from v^{k} as

vₖ→6th Order Butterworth Filter H(z)→\hat{v}ₖ^{L} (2)

and a time-varying 2nd order model is fitted to vₖ^{L}. The filter H(z) (in Eq 2) is designed to have a unity gain in the pass-band and roll-off at 600 Hz. Down sampling of the signal \hat{v}ₖ^{L} is performed to get vₖ^{L}.

\hat{v}ₖ^{L}→Down Sampler→vₖ^{L} (3)

This down sampling is preformed essentially to make the computation involved in tracking of pitch by Eq 4 numerically efficient and stable. A 2nd order time varying model P(z) is fitted to the signal vₖ^{L} as:

$${v}_{k}^{L} P ( z ) = \frac{( 1 - {z}^{- 2} ) ( 1 - {r}^{2} ) 0.5}{1 - r {\hat{p}}_{k} {z}^{- 1} + {r}^{2} {z}^{- 2}} {x}_{k} and \hat{p} \qquad ( 4 )$$

The model parameters are \hat{p} and r in which r is fixed pole position of the model and \hat{p} is varied as the pitch changes and this is tracked.

The Pitch Tracking filter in Eq 4 is written in time domain as:

$${x}_{k} = r {\hat{p}}_{k - 1} {x}_{k - 1} - {r}^{2} {x}_{k - 2} + \frac{( 1 - {r}^{2} )}{2} ( {v}_{k}^{L} - {v}_{k - 2}^{L} ) \qquad ( 5 )$$

When tracking is at steady state, the error eₖ=xₖ−vₖ^{L} in leastsquare sense is zero and is measured or computed using a fading filter given as:

$${e}_{k}^{2} Fading Filter [ \frac{1 - λ}{1 - λ {z}^{- 1}} ] {w}_{k} \\ {w}_{k} = λ {w}_{k - 1} + ( 1 - λ ) {e}_{k}^{2} \qquad ( 6 )$$

The model parameter \hat{p} is up-dated and tracked using the integrator relation

$${\hat{p}}_{k} = {\hat{p}}_{k - 1} - \frac{2 {e}_{k} {s}_{k - 1}}{{w}_{k}} μ \qquad ( 7 )$$

In the above equation sₖ is the gradient of the error eₖ is numerically obtained by using a gradient filter given as:

$${x}_{k} Gradient Filter [ \frac{r}{1 - r {\hat{p}}_{k - 1} {z}^{- 1} + {r}^{2} {z}^{- 2}} ] {s}_{k} \\ {s}_{k} = r {\hat{p}}_{k - 1} {s}_{k - 1} - {r}^{2} {s}_{k - 2} + {rx}_{k} \qquad ( 8 )$$

The pitch frequency Fₖ is estimated using equation

$${F}_{k} = \frac{1}{2 π} {cos}^{- 1} ( \frac{{\hat{p}}_{k}}{2} ) \qquad ( 9 )$$

The Equations 5, 6, 7 and 8 are used in tandem to track pitch in real-time. The pitch Fₖ as obtained using the equation 9 contains some noise, which can be seen as fast variations. This noise is due to the control methods in the tracking filter (Eqns 5, 6, 7 and 8). Normally the pitch of a human voice does not change so rapidly. So, we can reduce the noise by using the smoothing technique given below. Pitch is smoothed using a 2nd order Kalman Filter with a moving window of N=200 samples implemented via:

$${\dot{F}}_{k} = \{ ( N + 1 ) [ {\sum }_{i = 0}^{N - 1} {F}_{k - i} ] - [ {\sum }_{i = 0}^{N - 1} 2 ( i + 1 ) {F}_{k - i} ] \} g \qquad ( 10 )$$

where

$$g = \frac{6}{N ( {N}^{x} - 1 )}$$

and pitch variations are captured using the relation

\hat{F}ⱼ=\hat{F}ₖ₋₁+\dot{F}ₖ

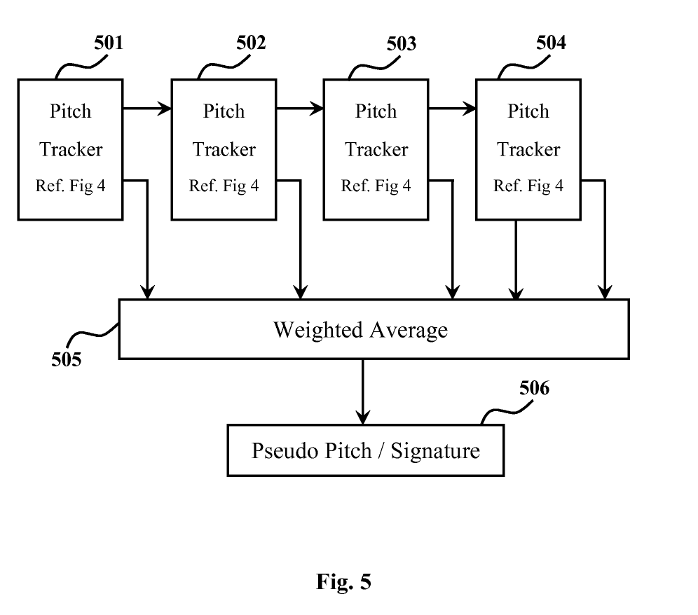

FIG. 5 shows a block diagram of a system an integrated multimodal real time pitch tracking system for evaluating the pseudo pitch/signature of a song sung by the singer according to one embodiment. In the pitch tracking process, the given song information is expected in a .wav file and this file pre-processed by removing the header information and converts the sign-magnitude fixed point numbers into floating point numbers and is designated as uk acting as an input to the mRpT pitch tracker.

.wav file→Data Converter→uk→mRpT pitch Tracker→\hat{F}ₖ

The pitch tracking digital circuits are shown in FIG. 4 with input as uₖ and as output \hat{F}ₖ. The data flow is shown in the same figure where model updating. The first block in the FIG. 4 is the model which receives the input uₖ. Conventional flow-charting technique is not adequate to present a complex adaptive filter circuits. Hence a circuit schematic along with data flow is shown in FIG. 4.

With respect to FIG. 5, the integrated multi-model real time pitch tracking algorithm includes cascading of four pitch trackers 501-504. Each pitch tracker 501 has two outputs. One is smooth pitch value and the other is the input for the next pitch tracker. The pseudo-pitch/signature is evaluated by calculating the weighted average of all the four smooth pitches. The overall block diagram of the integrated pitch tracking algorithm is shown in FIG. 5.

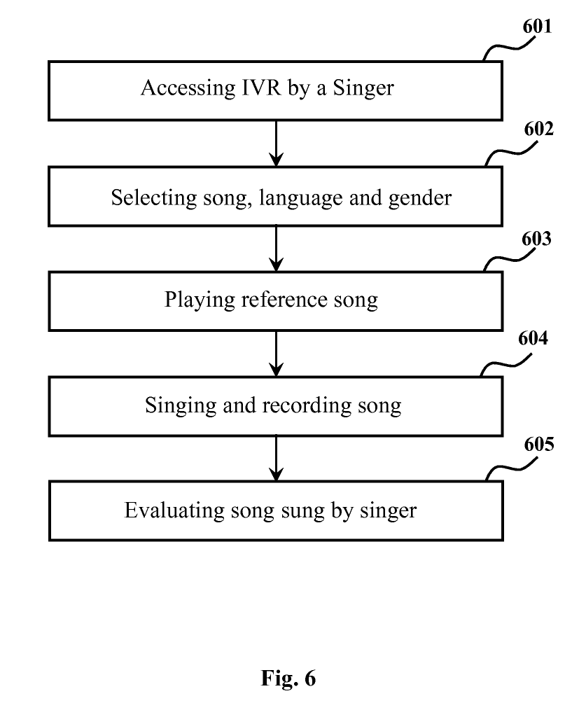

FIG. 6 shows a flow chart explaining the process of evaluating a singer using the model based pitch tracking system according to one embodiment. With respect to FIG. 6, an interactive voice response system is accessed through a communication means by a singer 601. A song is selected by the singer for singing 602. The selected song is played 603.

Then the selected song is sung by the singer. The song sung by the singer is recorded 604. The song sung by the singer is compared and evaluated with the selected reference song to calculate a score 605. The evaluation result is displayed. The process of evaluating includes estimating the pitch of the singer and the pitch of the reference singer who has played the reference singer to calculate the score corresponding to the degree of matching between the singer and the reference singer.

The process of accessing interactive voice response system involves initiating a phone call using a fixed line or a mobile phone. The process of selecting a song for singing involves selecting a desired song from a list of songs stored in a database. The process of selecting further comprises selecting options including language, gender and songs.

The method further comprises a process of selecting a listening option or recording option at the end of the playing of the selected song by a singer. The selected song is played again when the listening option is chosen by the singer. The recording option is selected by the singer to record the song sung by the singer. The process of recording the song sung by the singer includes playing karaoke during the singing of the selected song by the singer. The process of recording the song sung by the singer involves playing the recorded song along with karaoke and returning back to the recording mode after playing the recorded song sung by the singer. The process recording involves enabling the singer to sing the selected song for any number of times until the singer is satisfied with the recorded song.

The process of evaluating the song sung by the singer is initiated after receiving a confirmation of the recorded song from the singer.

The embodiments herein present invention provides a simple method to track the pitch of human being in real time using an algorithm. The pitch tracking method and system helps to track the pitch dynamically in real time by fitting a time varying model. The system and method may be used for singer evaluation and for short term identification of songs and human vocabulary.

Although various specific embodiments are provided herein, it will be obvious for a person skilled in the art to practice the embodiments herein with modifications. However, all such modifications are deemed to be within the scope of the claims.

It is also to be understood that the following claims are intended to cover all of the generic and specific features of the embodiments herein and all the statements of the scope of the invention which as a matter of language might be said to fall there between.

What is claimed is:

1. A model based real time pitch tracking system comprising:
a low pass filter;
a down sampler connected to the low pass filter;
a second order band pass filter connected to the down sampler;
a gradient filter connected to the second order band pass filter;
a fading filter connected to the second order band pass filter;
an integrator connected to the fading filter and to the gradient filter;
a first order filter connected to the integrator;
a pitch frequency estimator connected to the first order filter; and
a smoothing filter connected to the pitch frequency estimator;
wherein a lower order model is separated from a voice time series to perform a pitch tracking process in real time.

2. The system according to claim 1, wherein the low pass filter is a sixth order low pass Butterworth filter to receive the input voice series and to extract a lower order voice series from the input voice series in real time.

3. The system according to claim 1, wherein the down sampler performs the down sampling of the extracted lower order voice series to obtain a low order voice signal.

4. The system according to claim 1, wherein the second order band pass filter is connected to the down sampler and is provided with an algorithm to fit a second order time varying model to the output of the down sampler to obtain the model parameters related to the lower order voice series of the input voice.

5. The system according to claim 1, wherein the fading filter is connected to the output of the second order band pass filter through an adder and to the input of the second order band pass filter through a first delay unit, to calculate an error value in the measurement of the lower order voice in a pitch tracking process.

6. The system according to claim 1, wherein the gradient filter is connected to the second order band pass filter and provided with an algorithm to calculate a gradient of the measured error value in the measurement of the lower order voice in a pitch tracking process.

7. The system according to claim 1, wherein the integrator is connected to the gradient filter through a second delay unit to receive the gradient of the measured error value and to the input and to the output of the fading filter to receive the input lower order voice and the measured error value.

8. The system according to claim 1, wherein the integrator is connected to the fading filter and the gradient filter to calculate a model parameter related to the pitch of the lower order voice.

9. The system according to claim 1, wherein the pitch frequency estimator is connected to the integrator through a first order filter to receive the output of the integrator to calculate a pitch value of the input voice.

10. The system according to claim 1, wherein the smoothing filter is connected to the pitch frequency estimator to obtain a smooth pitch.

11. The system according to claim 1, wherein the smoothing filter is a second order Kalman filter.

12. A singer evaluation method using model based real time pitch tracking system, the method comprising:
accessing an interactive voice response system through a communication means by a singer;
selecting a song for singing;
playing the selected song;
singing the selected song by the singer;
recording the song sung by the singer;
evaluating the song sung by the singer with the selected reference song to calculate a score; and
displaying the evaluation result.

13. The method according to claim 12, wherein the process of evaluating includes estimating the pitch of the singer and the pitch of the reference singer who has played the reference singer to calculate the score corresponding to the degree of matching between the singer and the reference singer.

14. The method according to claim 12, wherein the method of accessing interactive voice response system involves initiating a phone call using a fixed line or a mobile phone.

15. The method according to claim 12, wherein the method of selecting a song for singing involves selecting a desired song from a list of songs stored in a database and selecting options including language, gender and songs.

16. The method according to claim 12, further comprising a process of selecting a listening option or recording option at the end of the playing of the selected song by a singer.

17. The method according to claim 12, wherein the selected song is played again when the listening option is chosen by the singer.

18. The method according to claim 12, wherein the recording option is selected by the singer to record the song sung by the singer.

19. The method according to claim 12, wherein the process of recording the song sung by the singer involves playing the recorded song along with karaoke and returning back to the recording mode after playing the recorded song sung by the singer.

20. The method according to claim 12, wherein the process recording involves enabling the singer to sing the selected song for any number of times until the singer is satisfied with the recorded song.

21. The method according to claim 12, wherein the process of evaluating the song sung by the singer is initiated after receiving a confirmation of the recorded song from the singer.
